(19) United States
(12) Patent Application Publication
(10) Pub. No.: US 2015/0142782 A1
(43) Pub. Date: May 21, 2015

(54) METHOD FOR ASSOCIATING METADATA WITH IMAGES

(71) Applicant: Trendalytics, Inc., New York, NY (US)

(72) Inventors: Karen Moon, New York, NY (US); Jian He, New York, NY (US)

(21) Appl. No.: 14/541,382

(22) Filed: Nov. 14, 2014

Related U.S. Application Data
(60) Provisional application No. 61/904,596, filed on Nov. 15, 2013.

(51) Int. Cl. G06F 17/30

(52) U.S. Cl. CPC G06F 17/30253; G06F 17/30554; G06F 17/30705
USPC 707/722

(57) ABSTRACT

A method for associating metadata to a set of images of a subject, the method executed on a computer processor obtains a taxonomy with initial attributes that are associated with the subject and forms an image set by receiving at least one initial image that contains the subject and accessing accounts on a social media platform to identify and store, in the image set, one or more related images from each account that also show the subject. The method associates, with one or more images from the image set, text data obtained from the accessed accounts as metadata and updates the taxonomy according to the metadata, then displays at least a portion of the image set and at least a portion of the metadata associated with the image set.

### CROSS REFERENCE TO RELATED APPLICATIONS

Priority is claimed from U.S. Ser. No. 61/904,596, provisionally filed on Nov. 15, 2013, entitled “Surfacing meta data in images using image matching to aggregate contextual data from disparate social media sources for a single image”, in the names of Karen Moon et al., incorporated herein by reference.

### FIELD OF THE INVENTION

The present invention relates to acquiring data related to a product or activity from multiple networked sites and more particularly to methods for acquiring statistical data about the product or activity from multiple social networking accounts using image identification and analysis tools.

### BACKGROUND OF THE INVENTION

Increased adaptation and use of social media network utilities has resulted in considerable growth in the amount of raw data that is stored and transferred over the internet. Ongoing use of existing social media utilities, including tools such as Facebook®, Twitter®, LinkedIn®, Pinterest®, Google+, and others, and continuing development of new ones, strongly suggests that social media will grow in significance as a source of information on what interests individuals as well as the general public.

Merchandisers of goods and services have recognized the value of participation in the explosive growth of social media and sponsor their own sites to take advantage of the increased networked user traffic. In designing and maintaining their own social media accounts, merchandisers have used a number of techniques for assessing consumer interest and tracking possible trends. Metrics have been developed and widely used for assessing consumer and trade interest, using conventional data gathering techniques. Statistics such as number of visits to a site or page, blog responses, voting metrics to measure “likes” and “dislikes”, and the like are regularly tracked by commercial entities in order to help gauge the success of products or campaigns and to help guide future efforts that might promote sales or adaptation of their product or service.

Considering the huge amounts of data that are potentially available for measuring trends and consumer interest, however, existing tools and techniques for extracting subjective data from the many thousands of social media accounts are somewhat limited, based on more conventional data access and aggregation models. Simply tracking numbers of visitors to a site or page and counting the number of consumers who express satisfaction with a product or message fails to take advantage of a significant amount of information on how consumers actually talk about products and services, what imagery truly appeals to them and captures their attention, and whether or not a given product or promotional presentation is having a positive impact on its intended audience. Statistics on numbers of visitors, numbers of likes/dislikes, and other readily available data are useful but do not provide the breadth of information a provider of goods or services needs for the more complex tasks of assessing consumer trends and designing and planning future product and marketing strategies, developing future product offerings, and budgeting time and resources for achieving business and market goals. Using conventional data collection and analysis techniques for obtaining information from networked sites, information on trends and trend-setters is difficult to glean from the gathered data, making it difficult for providers of goods and services to anticipate market direction based on current data.

Conventional techniques can be used to search for numbers of networked sites that reference a product or service in some way and to order this information in a usable format. However, conventional methods particularly suffer from a number of shortcomings, including the following:
(i) dependence on manual tagging of images. Images are tagged with metadata in a largely manual process that is inefficient and can be inaccurate. There can be very little metadata associated with an image at any site, and the metadata content can vary significantly from one site to the next.
(ii) limited search criteria that must be manually maintained and updated. Search criteria for data acquisition may be inaccurate and may not identify terms that are particularly productive for revealing information about products or services from individual social media accounts.
(iii) inability to use images that are routinely shared between social media account users.
(iv) language limitations, particularly with respect to slang and foreign terms. Terms that apply to various products or services, such as consumer products, can vary widely among segments of the consumer audience. In many cases, popular terms and slang used for various products can be confusing and may primarily be used regionally or used irregularly. Various types of products may be associated with a particular celebrity, musical group, etc., rather than with any manufacturer or merchandiser. As a result, data that is otherwise usable may be obscured by language that is unfamiliar to conventional search routines and techniques. In addition, foreign language terms can be difficult to identify for various products, confounding the task of obtaining information from social media accounts.

Among results of these shortcomings are ineffective responses to search queries, lost opportunities for improving customer experience at a website or social media account, incomplete measurement of external market data and segmentation, less accurate analysis of a company's internal data based on styles and product attributes, and an inability to use the accumulated data to influence how resources are allocated to meet customer needs.

Thus, it can be appreciated that there is a need for information gathering tools that are particularly effective in obtaining consumer data from social networking accounts, using a combination of image-recognition and language-expansion techniques to dynamically expand search criteria.

### SUMMARY OF THE INVENTION

It is an object of the present invention to advance the art of gathering data stored on networked sites, particularly from social networking accounts, and mapping this data with related data from e-commerce sites, publishers, blogs, and other content sites. Advantageously, embodiments of the present invention are able to dynamically expand search criteria based on iterative data search and gathering operation.

With this object in mind, the present invention provides a method for associating metadata to a set of images of a subject, the method executed on a computer processor and comprising:
a) obtaining a taxonomy that has an initial plurality of attributes that are associated with the subject;
b) forming an image set by receiving at least one initial image that contains the subject and accessing each of a plurality of accounts on a social media platform to identify and store, in the image set, one or more related images from each account, wherein the related images also show the subject;
c) associating, with the one or more images from the image set, text data obtained from one or more of the accessed plurality of accounts as metadata and updating the taxonomy according to the metadata; and
d) displaying at least a portion of the image set and at least a portion of the metadata associated with the image set.

These and other aspects, objects, features and advantages of the present invention will be more clearly understood and appreciated from a review of the following detailed description of the preferred embodiments and appended claims, and by reference to the accompanying drawings.

### BRIEF DESCRIPTION OF THE DRAWINGS

FIG. 1 is a logic flow diagram showing processing activity and outputs according to an embodiment of the present disclosure.

FIG. 2 is a logic flow diagram that shows iterative processing for accessing and obtaining data and image content from multiple social media accounts.

FIG. 3 shows image content as posted by account holders and as used to form an image set according to an embodiment of the present disclosure.

FIG. 4 is a diagram showing an arrangement for reporting provided by text and image processing according to an embodiment of the present disclosure.

### DETAILED DESCRIPTION OF THE INVENTION

The following is a detailed description of the preferred embodiments, reference being made to the drawings in which the same reference numerals identify the same elements of structure in each of the several figures.

### Terms and Definitions

Where they are used herein, the terms “first”, “second”, and so on, do not necessarily denote any ordinal, sequential, or priority relation, but are simply used to more clearly distinguish one element or set of elements from another, unless specified otherwise.

The term “set”, as used herein, refers to a non-empty set, as the concept of a collection of elements or members of a set is widely understood in elementary mathematics. The term “subset”, unless otherwise explicitly stated, is used herein to refer to a non-empty proper subset, that is, to a subset of the larger set, having one or more members. For a set S, a subset may comprise the complete set S. A “proper subset” of set S, however, is strictly contained in set S and excludes at least one member of set S.

In the context of the present disclosure, the term “networked site” refers to a logic processor or host processor at an address that is accessible from an external computer or equivalent logic processing apparatus that connects to the internet or other network wherein each networked host processor or computer has a corresponding internet IP address for access from other networked computers or processors on the network.

In the context of the present disclosure, the phrase “social media” has its conventionally accepted meaning. A social media platform or social media site is the Internet-based social media utility that provides a separate, individualized account for each of its users and provides facilities for sharing of information content between its users. Some examples of well-known social media platforms include Facebook, Twitter,

LinkedIn, and Pinterest. The social media platform maintains, for each registered user, a data storage location that has posted content that is readable to other users who have accounts on the social media platform, and that is writable by the registered user, and wherein an account stores for display, as posted content, at least one or more images and, optionally, accompanying text that is posted or “published” with the images. In practice, a social media account is intended to be personalized, such as to have information on personal preferences, likes, dislikes, and interests, as well as posted text and images showing events or subjects of interest to the account holder.

In the context of the present disclosure, the phrase “social media account” refers to a registered user account at a social media site. A person or other entity, including an organization, company, or corporation, holds a social media account that is password protected for exclusive read/write access for posting content and for management by that person or entity. Read access to posted content is generally permitted to a broad base of account users or to all participants in a particular social media group, based on setup selections that are typically controlled by the social media account user.

In the context of the present disclosure, the phrase “subject of interest” refers to a product or activity that interests at least some portion of the population and about which people can post text and images.

In the context of the present disclosure, the term “image cluster” describes a set that has, as members of the set, two or more images that show the same subject of interest.

In the context of the present disclosure, the term “content post” refers generally to display of images and/or text information in a social media posting. The more general term “content entry” refers to content posts at social media accounts as well as information or images available in a web page or other site controlled by a product merchandizer; in a blog posting; or in an article, including a commented article on the product or other subject of interest. In general, “posting” of images or text refers to content entry that has been done in a social media account by a registered participant of a social media platform.

In the context of the present disclosure, the terms “user”, “viewer”, “observer”, and “subscriber” are considered to be synonymous.

In broad usage, the term “taxonomy” generally refers to a data classification scheme that relates structural components, categories, and attributes to a subject. Taxonomies are designed to organize data by category and attributes so that the data can be readily organized, stored, and accessed, such as using search tools. In the context of the present disclosure, the term taxonomy is used similarly, to describe the particular data scheme that relates categories, attributes, and terminology to a corresponding product or activity that is the subject of interest. Different web sites can employ different taxonomies for various products or for various subjects, such as for terms used in assigning tags to images and other site content, enabling search utilities to access information from them. For search tools, a goal in efficient database aggregation is to employ a taxonomy that is flexible enough to adapt to how information is organized from numerous other sources and that is also easily accessed and used to extract the collected information for searching, analysis, and presentation. The taxonomy is not itself a search schema but can be used by search tools; the taxonomy is also used as a resource for generating search parameters and attributes for obtaining data or “surfacing data” related to a specific subject of interest or product attribute and for searching user accounts at various types of content sites. In the retail world, for example, a retailing entity can better understand its own sales results, anticipate sales trends, and measure performance data if the taxonomy and overall classification of their data is more accurate.

Embodiments of the present invention address the need for improved information-gathering, monitoring, and reporting, and for improved tools and techniques for searching social media accounts and other networked sites. Embodiments of the present invention provide methods for developing and refining search utilities used for obtaining information on a subject of interest, such as a particular product, service, or activity, using utilities for dynamically updating text tag and site content searching criteria and applying image recognition techniques for locating information related to the subject and for obtaining images related to the subject. Of particular interest for embodiments of the present disclosure are social media accounts that can hold a significant amount of data that relates to people's interests and attitudes and can be used to forecast trends. Obtaining this data and presenting it in a usable fashion has heretofore proved elusive using conventional searching and web-crawling techniques.

An embodiment of the present disclosure provides a method for associating metadata to a set of images of a subject of interest, the method executed on a computer processor that obtains and stores a taxonomy having an initial plurality of attributes that are associated with the subject. The processor also receives at least one initial image that shows the subject and forms an image set using this image, supplemented by identifying and storing similar images. The addition images of the subject of interest can be accessed from accounts on one or more social media platforms. At least in accounts where such images are detected, the processor performs analysis of the text data in posted content according to the obtained taxonomy. Text data from the social media accounts is parsed to obtain metadata that relates to the subject of interest. Other related metadata that is obtained includes information about number of accounts showing an image or expressing awareness or interest in the subject of interest. The processor updates the stored taxonomy based on the obtained metadata. The resulting image set is available for display from the processor, as well as at least a portion of the metadata that is generated in searching through the social media accounts. Metadata associated with the image set can relate to social engagement information, such as data on particular contacts or associations, from a social media account.

### Overall Process for Trend Analysis

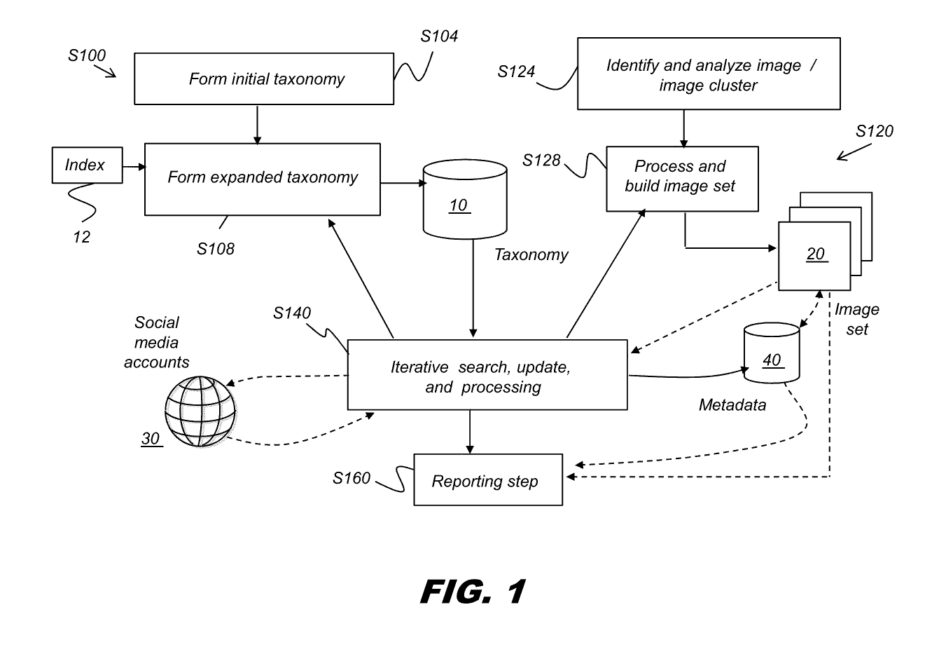

The logic flow diagram of FIG. 1 shows a sequence for trend analysis based on obtaining content and metadata from social media accounts. The broad preparatory steps are generating a suitable taxonomy in a preparatory step S100 and analyzing the starter image or image cluster and setup of an initial image set 20 in a preparatory step S120. Iterative processing then follows in iterative step S140, with searching for text and image content in social media postings and updating both the expanded taxonomy 10 and the image set 20, as well as providing metadata that relates to individual images and to user accounts and trends. A reporting step S160 then stores and displays the results of iterative search and processing, displaying the image set 20 and related statistical data and metadata associated with search processing and with image set 20.

Still referring to FIG. 1, preparatory step S100 has a form initial taxonomy step S104 in which an initial taxonomy 10 is set up by a user. The initial or “seed” taxonomy gives a starting point for searching for web-posted information that relates to a specific product or activity of interest. Setup of the initial taxonomy 10 can be based on existing indices 12, conventional sources that use routine analysis of existing web site taxonomies, such as from shopping sites, trend lists and indicators from magazines and other publications, ranking lists of blog participants, and the like. A form expanded taxonomy step S108 then executes, supplementing initial index 12 data using information about the product or activity of interest obtained from influencer sites, such as manufacturer sites, sites sponsoring or related to well-known users, or high-traffic sites frequented by users who are interested in the product or activity. Index 12 can also reference product feeds that include descriptions of a subject of interest from web sites that offer items for sale, magazines and other publications that provide online content, web-based forums for expression of personal opinion and answers to inquiries, and product reviews and ratings information provided from sites offering products or services related to the subject of interest. Index 12 entries can include weighting data, allowing more or less influence to particular input, based on measured traffic, popularity, history, or preferences of those performing the search and taxonomy building steps.

Form expanded taxonomy step S108 in FIG. 1 updates taxonomy 10 with additional information according to the expanded site locations indicated in index 12. It can be appreciated that additional information from index 12 can help to update the seed taxonomy, adding useful terms that can help in identifying references for measuring attitudes and interest related to the subject product or activity.

Still referring to FIG. 1, preparatory step S120 includes an image analysis step S124 that provides an initial image or images to a processor for beginning to form image set 20, corresponding to the subject of interest. An image set generation step S128 is used in the initial and iterative steps that process image data and generate the image set 20 with additional members as a result of search activity that accesses and parses social media accounts, described with reference to subsequent steps.

In the processing sequence of FIG. 1, steps S100 and S120 and their substeps S104, S108, and S124 may have some procedures that can be executed in an automated manner, using data from a range of networked sites and sources; other procedures may be performed by manual entry of data or selection of search criteria, images, etc. Iterative step S140, however, is the automated search engine that searches multiple social media accounts 30 using the image set 20 and updated taxonomy 10 information. Iterative step S140 performs a number of functions, including further update of taxonomy 10 based on search results and further building of image set 20 according to image processing routines that step S140 initiates as it detects appropriate images in searching various social media accounts 30.

Reporting step S160 in the processing sequence of FIG. 1 formats and provides the processed search results, including images and metadata, so that they can be readily accessed, understood, and used by a user of the system for trends assessment and decision-making.

### Example Application

The steps shown in FIG. 1 can be more clearly understood by considering an example case, which also shows some of the advantages of the method of the present invention and how this method differs from conventional data gathering and analysis techniques and offers expanded opportunities for taking advantage of the significant amounts of information that are available from social media accounts.

There is particular interest for the fashion industry to detect and monitor attitudes, opinions, and trends from a broad population base, such as that provided by users of various social media platforms. For this particular example, consider a fashion buyer or planner considering the market for designer jeans. In making allocation decisions, it is beneficial to obtain information on consumer interest. So-called “distressed jeans” or “ripped jeans” are a fashion item currently popular and are the subject of interest for the example description of processing that follows. An initial taxonomy for these jeans in form initial taxonomy step S104 of FIG. 1 would include a category for distressed jeans with two descriptive terms that have been widely used to describe and market the product:
(i) “distressed jeans”; and
(ii) “ripped jeans”.

For expanding this initial taxonomy, index 12 is used. An initial search using index 12 that lists key sites for designers, models, celebrities, and other primary influencers of the fashion world, executed by a computer process, aggregates data from these key sites and detects high incidence of another descriptive term for this product: “distressed denim”. Based on this high incidence, step S108 adds this term to the taxonomy 10 for the subject of interest. Taxonomy 10 now has a small number of terms that can be used to provide a productive search of social media accounts 30 in subsequent processing.

As also shown in FIG. 1, one or more images are also needed for beginning image set 20, which also serves as a tool in obtaining metadata that is useful for the trend analysis. Image processing utilities in image set generation step S128 are used to analyze image content and to generate criteria that can be used to identify the same image that may be repeatedly copied in various social media accounts, or “pinned”, “re-pinned”, re-blogged, shared, “tweeted”, or otherwise selected or specified, as well as to identify similar images that also show jeans of this type.

At this point in processing, a basic search taxonomy 10 and an image set 20 consisting of at least one initial image can be provided to “seed” iterative step S140 so that searching of social media accounts 30 can proceed.

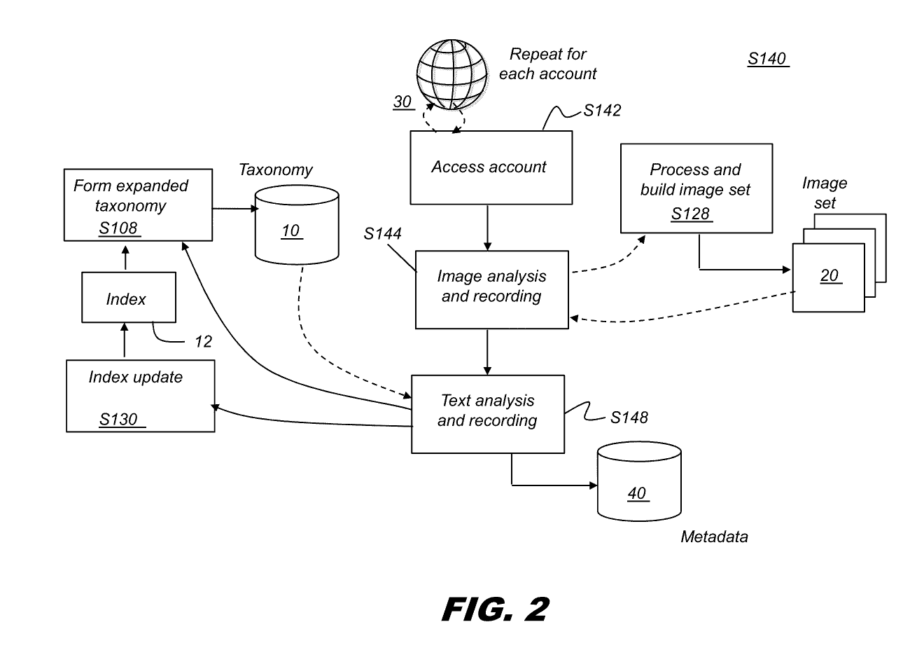

Continuing with the fashion buyer/distressed jeans example sketched out previously, it is instructive to consider how iterative step S140 operates to obtain relevant information from social media accounts and to further build both taxonomy 10 and image set 20. The logic flow diagram of FIG. 2 shows a sequence for iterative step 140, repeated in an automated manner for each of a number of social media accounts.

An account access step S142 gains access to the social media account. A number of methods can be used for accessing social media accounts to gain access to text and image content. By way of example, social media accounts can be accessed in an automated manner using mechanisms such as their REST (REpresentational State Transfer) APIs (Application Programming Interfaces). Each social media account is considered a resource in the respective API. The state of each resource can then be processed via the HTTP (Hypertext Transfer Protocol) GET method. Alternatively, a web crawler utility can be used to download the web page associated with a given social media account. Processing software can then parse the web page content for the account in order to retrieve the desired data.

An image processing step S144 searches the account for image content, using the accumulated results stored in image set 20. Image processing step S144 can initially check to determine whether or not the user account includes one or more of the stored images in image set 20. Instances of image use are recorded. In addition, image analysis can also be applied to unrecognized images that are posted in the user account, in order to determine if similar or related images that appear to show the same subject of interest are shown.

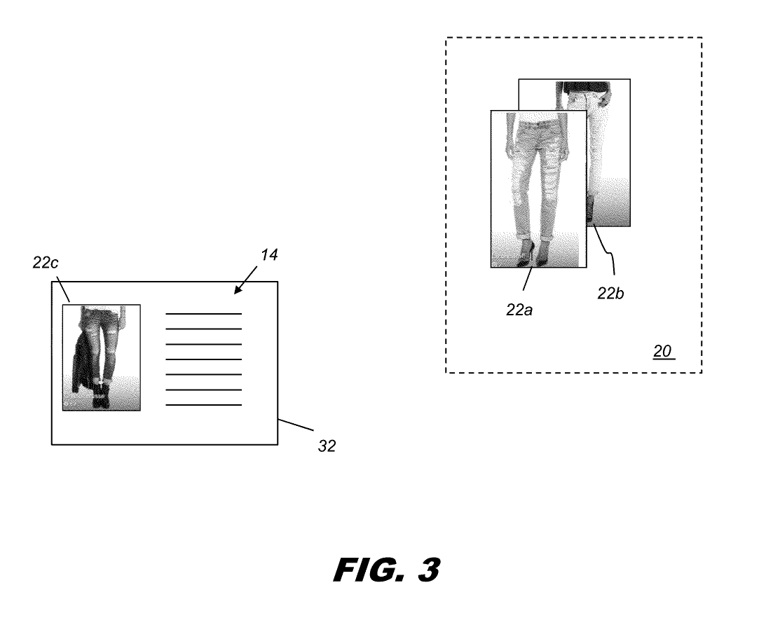

Continuing with the fashion jeans example, FIG. 3 shows image set 20 with two member images 22a and 22b for distressed jeans. A user account posting 32 includes text 14 posting and also posts an image 22c that is not currently included in image set 20 but that would appear, according to image analysis techniques, to show a slightly different version of the same subject. Where this is the case, image processing step S144 of FIG. 2 may determine that image 22c belongs as a member of image set 20 and should be added. Image processing step S144 then provides image 22c to image set generation step S128 for its addition and use as part of image set 20. It should be noted that once a new image is added to image set 20, this expanded image set 20 is then used in subsequent searches and analysis of user social media accounts. Because of this, a broader range of search criteria are effectively provided and results of continued search activity through social media accounts can be improved.

Image processing tools for identifying similar image content from different images are well known to those skilled in image science and include a range of utilities often referred to as content-based image retrieval. Familiar methods include, but are not limited to, techniques commonly classified as keypoint matching, histogram matching, image differencing, corner detection, interest point detection, and structural similarity detection, for example.

According to an embodiment of the present disclosure, multi-resolution wavelet decomposition, familiar to those skilled in the image processing arts and widely used for image compression, is used for assessing image similarity. In this processing, similar images are compared against a target image in a pre-indexed database. Because the coefficients of a wavelet decomposition provide information that is independent of the original image resolution, a wavelet-based scheme allows the resolutions of the query and the target to be effectively decoupled, simplifying the analysis needed to identify similar objects and features. Using this approach, queries can be specified at any suitable resolution used for display, including resolutions that differ from the target image. Image dimensions are relatively unconstrained. Running time and storage requirements are independent of database image resolution. Wavelet decompositions can be particularly useful for extracting and encoding edge information. When doing query-by-sketches, edges from user drawn strokes are likely to be among the key features identified. Wavelet decompositions are typically fast and easy to compute, are straightforward to set up and execute, and require only linear time proportional to image size.

As image set 20 grows with addition of images detected from user accounts and other content sources, subsequent searches of user accounts can improve in quality, since there are more example images that can be used for comparison with images provided on any particular site.

Referring back to iterative step S140 processing described with reference to FIG. 2, a text processing step S148 then collects and processes posted text data that is associated with the image for the social media account, using information from taxonomy 10. Text analysis provides various metadata for use with images in image set 20. In addition, text analysis processes search for instances of category and descriptive terms and record results of this detection for use in subsequent processing and reporting. Thus, for example, statistics are maintained on number of sites at which the phrases “ripped jeans”, “distressed jeans”, or “distressed denim” occur.

In addition to detecting use of established terms and phrases, text analysis in step S148 also tracks and responds to repeated instances of other terms and phrases that repeat with some frequency. For the particular example described previously, text analysis detected a significant number of references to “boyfriend jeans” at various user social media accounts. Where the number of accounts with similar text construction exceeds a predetermined threshold, text analysis and recording step S148 of FIG. 2 cooperates with form expanded taxonomy step S108 to dynamically adjust taxonomy 10 for additional pertinent categories and/or related descriptive terms. For the particular example given herein, search routines record and respond to instances of an expanded list of any of descriptive phrases:
(i) “ripped jeans”;
(ii) “distressed jeans”;
(iii) “distressed denim”; and
(iv) “boyfriend jeans”.

Further taxonomy expansion can be done, for example, by breaking a phrase into individual words, or by substitution of individual words with similar terms or phrases. Similarity can be based on known synonyms. The text data is associated with images in the image set and can be used for tagging or updating tags assigned to the images, for example.

Image and text processing steps S144 and S148 work together in order to provide improved search criteria using both images and text. Where images relevant to the subject of interest are posted at a particular account, for example, a higher weighting is given to text analysis results that are obtained from that account. Processing of text content differs from one user account to the next, based in part on whether or not any particular user account includes image content from image set 20 or image content that is related and used to build image set 20. Dynamic adjustment and update of taxonomy 10 search terms and image set 20 help to make search routines more effective in obtaining information from user accounts.

It can be appreciated that any of a number of benchmark values can be used for determining which data is to be considered for update. Thus, for example, a benchmark value may be applied requiring that a certain number of instances of a descriptive term must be made before the term is considered for update of taxonomy 10. A predetermined benchmark value may alternatively be set for number of occurrences of an image at different accounts before the image is added to image set 20.

Using the search techniques described hereinabove with reference to FIGS. 1 and 2 also allows the collection and use of foreign terms for building taxonomy 10 and metadata 40 related to the subject of interest and image set 20. This feature enables access to social media account information for users in specific countries or regions. The additional information can be included to provide information from a more global base of data; alternatively, information extracted from social media sites can be separately identified by language. This capability can allow a merchandiser to identify and assess differences in attitudes by country or culture and help to show where particular products are likely to be more widely accepted. Language classification methods usable for foreign language differentiation are known to those skilled in the text data analysis arts.

Searching user accounts using image processing step S144 of the FIG. 2 sequence can be particularly fruitful where the account postings may be in language that is considered “foreign” to the text processing step S148. References to widely known celebrities or to terms used in the foreign language that relate to a product or subject can help to guide marketing and merchandising decisions where a foreign market is being considered.

Iterative processing methods can apply algorithmic approaches used for neural network and other trained logic systems. Thus, for example, image processing utilities can be used that apply learned system logic to the task of identifying similar images or similar products.

As shown in FIG. 2, an optional index update step S130 can be executed based on results of text processing step S148 for one or more social media accounts 30. For example, there can be numerous references in accounts 30 to particular individuals, publications, or organizations that may not yet be referenced in index 12. However, continued references at accounts that include text and image content related to the subject of interest can indicate the relevance of a particular entity to the subject of interest. As an example, considering the set of social media accounts 30 that positively identify and show the subject of interest, search and image analysis utilities can also detect references to, or images of, a particular celebrity or a particular magazine or publication. Text processing step S148 reports this type of information to index update step S130 that can then determine whether or not to update index 12 (FIG. 1) in light of the newly obtained data. Thus, a site for an actress, model, or other celebrity may be considered a “trendsetter” related to the product of interest and may prove to be a useful addition to index 12 for helping to generate a more useful taxonomy 10. In this way, a dynamically adjusted index 12 can be provided for generating an updated taxonomy 10. Results from index 12 update can then be used to improve searching through social media accounts with dynamically generated search criteria. In this way, data extracted from text and images in social media accounts can help to map disparate sources of information, even where different terms and attributes are used in these sources.

Index update step S130 can also be responsive to slang, verbal shorthand, colloquial terms, and alphanumeric references to products of interest or influencers, as well as to foreign language terms that relate to sites referenced in index 12 (FIG. 1). Similar language problems to those described earlier with respect to distressed jeans also apply for groups such as influencer entities and brand names. As an example of this type of verbal anomaly in the fashion industry: brand name “Diane Von Furstenberg” is also referred to as “DVF”. As another example, fashion influencer named Leandra Medine is referred to by a blogger name of “Man Repeller”, so that an index of influencers needs to take both names into account for searching through web site content. Embodiments of the present disclosure allow index and index-generating algorithms to adapt to such anomalies so that a more complete and effective taxonomy can be generated.

The iterative processing that is executed in step S140 of FIG. 2 can be repeated periodically, such as daily, every other day, weekly, or monthly, for example, in order to track interest and obtain trend-related data relative to the subject of interest. Repeated iterations tend to increase the accuracy of the information that is obtained, since index 12, taxonomy 10, and image set 20 tend to grow as search activity is repeated. Different weights can be applied to particular posted content or to various combinations of information posted in user accounts, helping to show trends and changes of interest more accurately.

### Results Reporting

Referring back to FIG. 1, results reporting makes available useful information that helps to show the level of consumer interest and to indicate trends for various goods and services. Various views of the obtained data can be presented.

Metadata that can be provided as a result of searches and processing potentially includes a wide range of information, including the following:
(a) trend information obtained from user accounts on various social media platforms, including timestamp information giving date(s) of postings;
(b) related terms, subjects, concerns, and interests that are reflected in user accounts;
(c) data on number of social media accounts searched and number of accounts referencing or posting text or images related to the subject of interest;
(d) profile data, where available, on the user audience, including age, sex, income, geographical distribution, etc.;
(e) references that were made, from accounts that posted content related to the subject of interest, to unrelated subjects that might be of interest to advertisers, such as to music groups, food items, celebrities, or other subjects;
(f) image-related information for posted images, including which images appear to have the most appeal.

Metadata can be weighted according to factors that might show higher interest in the subject of interest or in related subject content. For the fashion jeans example, data from sites that include a high number of references to fashion items, include a relatively large number of images for the jeans type described, or make a number of references to particular merchants, models or other celebrities, manufacturers, or to other entities, may indicate a participant whose input should be given more or less weight than other accounts.

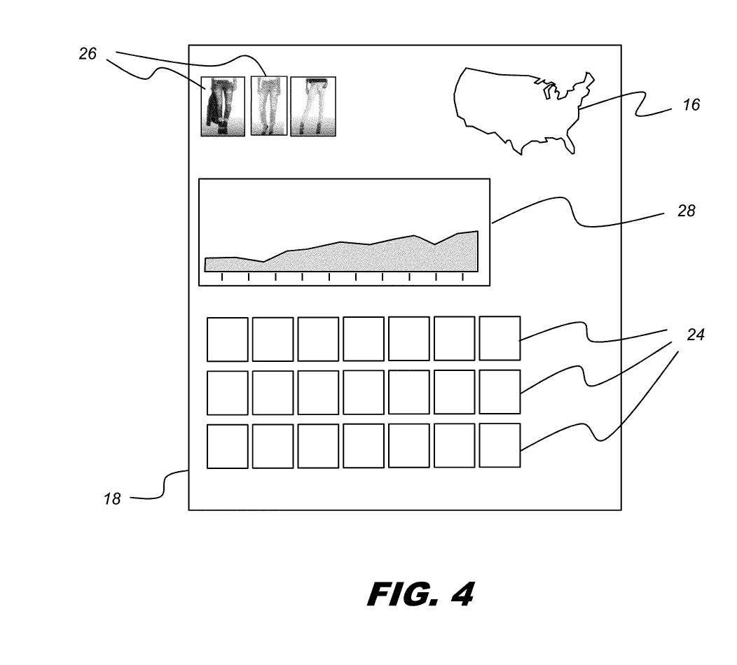

By way of example, FIG. 4 shows, in simplified schematic form, a report layout scheme for graphically showing results of social media account searches according to an embodiment of the present disclosure. A display 18 shows a graph 28 that indicates metadata or statistical data extracted from social media accounts and related to the subject of interest. Display 18 can show a view of the metadata in graph 28, such as a histogram showing frequency of references for various dates. Any of a number of types of metadata can be displayed as graph 28, including frequency of use of specific terms related to the subject, number of occurrences of one or more specific images related to the subject, or number of accounts having both text and image references to the subject. For example, graph 28 may show number of postings related to the subject of interest over a time period. The time period can be selectable or adjustable by the viewer. Images 26 may reference one or more recent postings and act as links, directing the viewer to corresponding social media sites. Images 24 are a subset obtained from the full image set 20 that has been formed as described in FIG. 2 and can reference search results, showing thumbnail images that correspond to images shown for various accounts. Clicking on a thumbnail image 24 or 26 directs the viewer to the corresponding social media site or to a listing of accounts from which a particular account can be accessed for viewing. A particular image 24 can also have an associated data field that indicates the number of postings of the image. Clicking on or otherwise selecting a particular image 24 can initiate display of a report with a graph 28 that shows statistical data on number of postings that showed the image 24, such as with number of occurrences plotted over time, for example.

A map 16 can show the geographical distribution for the obtained data. According to an embodiment of the present invention, map 16 can be used to select localized data, such as data by state or by national region, for example, where geographical location can be determined from user accounts. Thus, map 16 can be used to provide a geographically based view of the collected data. Map 16 can also be used to show work pending or in process, as well as social media search results.

In addition to the layout scheme shown in FIG. 4, other arrangements can be provided, including multiple-page arrangements that help to reduce the amount of data available on a single page. Additional text and reporting fields can be provided in order to list and organize results from searches of social media accounts.

In addition to data extracted from and related to social media accounts, reporting can also be provided on other types of content entry that is detected from a web page or other site that is controlled by a product merchandiser; in a blog posting; or in an article, including a commented article on the product or other subject of interest. By combining the available data from multiple types of accounts, an assessment of relative interest in a product or service can be obtained.

### Applying Metadata to Images

Embodiments of the present invention automate the tagging of images with metadata to assist in search and tracking, for example. The images displayed to the viewer, such as images 24 in the display 18 of FIG. 4, can be associated with metadata obtained from searching and aggregating data obtained from numerous social media accounts.

Date and time stamp information is also included as metadata, allowing data to be organized, analyzed, and displayed according to timing information.

According to an embodiment of the present disclosure, a computer program executes stored instructions that perform analysis on image data accessed from an electronic memory in accordance with the method described. Programmed instructions configure the processor to form an analysis engine for calculating and evaluating image data. As can be appreciated by those skilled in the image processing arts, a computer program of an embodiment of the present disclosure can be utilized by a suitable, general-purpose computer system, such as a personal computer or workstation. However, many other types of computer systems can be used to execute the computer program of the present disclosure, including a dedicated processor or one or more networked processors. The computer program for performing the method of the present disclosure may be stored in a computer readable storage medium. This medium may comprise, for example; magnetic storage media such as a magnetic disk (such as a hard drive) or magnetic tape; optical storage media such as an optical disc, optical tape, or machine readable bar code; solid state electronic storage devices such as random access memory (RAM), or read only memory (ROM); or any other physical device or medium employed to store a computer program. The computer program for performing the method of the present disclosure may also be stored on computer readable storage medium that is connected to the image processor by way of the internet or other communication medium. Those skilled in the art will readily recognize that the equivalent of such a computer program product may also be constructed in hardware.

It will be understood that the computer program product of the present disclosure may make use of various image manipulation algorithms and processes that are well known. It will be further understood that the computer program product embodiment of the present disclosure may embody algorithms and processes not specifically shown or described herein that are useful for implementation. Such algorithms and processes may include conventional utilities that are within the ordinary skill of the image processing arts. Additional aspects of such algorithms and systems, and hardware and/or software for producing and otherwise processing the images or co-operating with the computer program product of the present disclosure, are not specifically shown or described herein and may be selected from such algorithms, systems, hardware, components and elements known in the art.

The invention has been described in detail with particular reference to presently preferred embodiments, but it will be understood that variations and modifications can be effected that are within the scope of the invention. Thus, for example, embodiments of the present invention could be used for measuring interest and trends for a range of different products or services.

The presently disclosed embodiments are therefore considered in all respects to be illustrative and not restrictive. The scope of the invention is indicated by the appended claims, and all changes that come within the meaning and range of equivalents thereof are intended to be embraced therein.

The invention has been described in detail, and may have been described with particular reference to a suitable or presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

1. A method for associating metadata to a set of images of a subject, the method executed at least in part on a computer processor and comprising:
a) obtaining a taxonomy that has an initial plurality of attributes that are associated with the subject;
b) forming an image set by receiving at least one initial image that contains the subject and accessing each of a plurality of accounts on a social media platform to identify and store, in the image set, one or more related images from each account, wherein the related images also show the subject;
c) associating, with the one or more images from the image set, text data obtained from one or more of the accessed plurality of accounts as metadata and updating the taxonomy according to the metadata; and
d) displaying at least a portion of the image set and at least a portion of the metadata associated with the image set.

2. The method of claim 1 wherein accessing each of the plurality of accounts further comprises comparing the at least one initial image with content of one or more posted images in the account.

3. The method of claim 1 wherein associating text data comprises associating text from a first account that is posted in a first language and associating text from a second account that is posted in a different language.

4. The method of claim 1 wherein the metadata associated with the image set further includes a number of accounts posting one or more of the images in the image set.

5. The method of claim 1 wherein the metadata associated with the image set further includes information related to account geographical location.

6. The method of claim 1 wherein the metadata associated with the image set relates to social engagement information from a social media account.

7. The method of claim 1 wherein forming the image set further comprises executing one or more image analysis routines.

8. The method of claim 1 further comprising generating additional metadata from social media accounts that do not have posted images showing the subject of interest.

9. The method of claim 1 wherein the taxonomy is generated using information obtained from a merchandizer web site.

10. A method for associating metadata about a product to an image, the method executed on a computer processor and comprising:
a) obtaining an initial taxonomy that comprises at least one product category and an initial plurality of attributes associated with the at least one product category;
b) obtaining an index of networked sites that are associated with the at least one product category;
c) obtaining image data to form an image set from at least one image that corresponds to the at least one product category;
d) generating an updated taxonomy by adding to the initial plurality of attributes according to text acquired by collecting data according to the index of networked sites;
e) acquiring additional image data for one or more additional images that show the product and adding the additional image data to the image set;
0 obtaining image metdadata associated with the product category by searching through a plurality of social media accounts using attributes from the updated taxonomy and using images from the image set; and
g) displaying the image set and metadata processed from the updated taxonomy.

11. A method for associating metadata associated with a product with a plurality of images that show the product, the method executed on a computer processor and comprising:
(a) obtaining an initial taxonomy for the product that comprises a plurality of attributes associated with the product;
(b) obtaining a digital image set that contains at least a first image of the product;
(c) generating an updated taxonomy for the product and updating the digital image set by a repeated sequence of:
(i) searching a content site to identify the at least the first image or a similar image of the product;
(ii) extracting and storing at least a portion of the image data and text data obtained from the content site;
(iii) generating and storing metadata related to the product according to information obtained from the content site; and
(d) displaying at least a portion of the updated digital image set and displaying information obtained from the extracted text data.

12. The method of claim 11 further comprising repeating steps (c) and (d) at periodic intervals and displaying results obtained over the periodic intervals.

13. The method of claim 11 further comprising responding to a viewer instruction that identifies a member of the displayed image set by displaying metadata that relates to the identified member of the displayed image set.
